(19) United States
(12) Patent Application Publication
(10) Pub. No.: US 2025/0154295 A1
(43) Pub. Date: May 15, 2025

(54) METHOD OF PREPARING A TITANIUM-MODIFIED CR/SILICA CATALYST

(71) Applicants: ECOVYST CATALYST TECHNOLOGIES LLC, Malvern, PA (US); ECOVYST CATALYST TECHNOLOGIES LLC, Conshohocken,Pennsylvania, PA (US); ECOVYST INC., Conshohocken, Pennsylvania, PA (US)

(72) Inventors: Yatao Rachel HU, Malvern, PA (US); Myoung LEE, King of Prussia, PA (US); Chong ZHAO, Cherry Hill, NJ (US); Larissa DING, Audubon, PA (US)

(21) Appl. No.: 18/728,411

(22) PCT Filed: Jan. 13, 2023
(86) PCT No.: PCT/US2023/060670

§ 371 Date: Jul. 11, 2024

Related U.S. Application Data
(60) Provisional application No. 63/299,869, filed on Jan. 14, 2022.

(51) Int. Cl. C08F 4/24; C08F 4/02

(52) U.S. Cl. CPC C08F 4/24; C08F 4/025

(57) ABSTRACT

A method for making high-PV titanium-modified Cr/Silica (Cr/Ti/Silica) catalyst precursor, with PV>1.5 ml/g, comprising: providing a silica support, typically based on a desired porosity, purity, particle size and size distribution; providing a coating solution containing a Cr-containing compound, a Ti-containing compound, and a solvent; mixing the coating solution with the silica support to form a catalyst preparation mixture; and drying the catalyst preparation mixture to produce a Cr/Ti/Silica catalyst precursor. The Cr/Ti/Silica catalyst is surprisingly tolerant to the presence of water in the catalyst preparation mixture, as shown by it containing water in an H₂O:Ti molar ratio ranging from 2-50 with negligible effect on the pore volume (PV) and the MI potential of the Cr/Ti/Silica catalyst precursor. A catalyst, such as an olefin polymerization catalyst, made by the method is also disclosed.

This application claims priority to U.S. Provisional Patent Application No. 63/299,869, filed Jan. 14, 2022, which is hereby incorporated by reference in its entirety.

### FIELD

This disclosure relates to processes for the preparation of titanium-modified Cr/Silica catalyst precursors (Cr/Ti/Silica precursors), particularly Cr/Ti/Silica catalyst precursors of high pore volume (PV). These catalyst precursors may be activated for use in polymerization reactions, such as polymerization of olefins. The disclosure additionally relates to activation of the catalyst precursors and their use in the polymerization of α-olefins.

### BACKGROUND

One major family of catalysts for use in the polymerization of olefins, particularly polymerization of ethylene to produce high-density polyethylene (HDPE), comprises chromium oxide on a porous inorganic support such as silica, alumina, titania, thoria, magnesia, and mixture thereof, with silica being the most widely used. This type of catalyst is referred as Phillips catalyst (Cr/Silica). Commercial production of Cr/Silica catalysts typically involves the preparation of the silica support with the required porosity [surface area (SA), pore volume (PV) and pore size distribution], purity, particle size and size distribution, among other considerations; then incorporating a chromium-containing compound to the silica support to form the Cr/Silica catalyst precursor; followed by activation to generate the Cr/Silica catalyst.

HDPE of higher Melt Index (MI) or lower Molecular Weight (MW) is advantageous for certain applications. It is well known that the porosity of the Cr/Silica catalyst plays a critical role in controlling the average MW, or MI, of the HDPE produced. When other things being equal a Cr/Silica catalyst of higher PV in general leads to HDPE of lower average MW or higher MI. It is also well known that the incorporation of small amounts of titanium in Cr/Silica catalysts can have a substantial boosting effect on the MI of the HPDE produced, in addition to boosting catalyst activity and broadening polymer molecular weight distribution (MWD). Therefore, a catalyst that combines high PV and Ti modification is of great commercial interest to the industry.

Preparation of catalyst with high PV requires maximizing the PV of the silica support during support production and minimizing the PV reduction (or pore shrinkage) during subsequent incorporation of Cr-containing compound and/or other compound(s) containing the desired catalyst modifier(s) such as Ti. Maximizing support PV can be achieved by several techniques that are well known to people skilled in the art, such as replacing water in silica hydrogel with an organic solvent that has significantly lower surface tension before drying the hydrogel or drying the silica hydrogel under supercritical conditions. Minimizing the PV reduction during the subsequent incorporation of Cr and/or Ti-containing compound is achieved by conducting the Cr and/or Ti incorporation in a substantially water or moisture-free environment.

There have been numerous reports in prior art on various techniques to incorporating Ti-containing compound in Cr/Silica catalyst, such as co-gelation in which Ti is incorporated into the silica gel at the very early stage of silica support production (U.S. Pat. Nos. 3,887,494; 4,081,407; 4,522,987); mixing silica support or Cr/Silica particles with a solution of Ti-containing compound followed by drying (U.S. Pat. Nos. 3,622,521; 6,531,565); through reaction between silica support or Cr/silica with a volatile Ti-containing compound in a fluidize reactor at elevated temperature (U.S. Pat. Nos. 3,780,011; 4,016,343). The latter two cases are collectively referred to as surface titanation. The Ti-containing compounds used for surface titanation are typically chosen from the following groups and a substantially water/moisture free environment is required in the prior arts cited above.
(R′)ₘTi(OR)ₙ
(R′O)ₘTi(OR)ₙ
TiX₄
Ti(acac)₂(OR)₂, wherein “acac” is acetylacetonate

Chevron-Phillips has disclosed several inventions related to aqueous titanation of Cr/Silica catalyst for ethylene polymerization. The inventors state that preparing the Cr/Ti/Silica catalyst according to prior art requires rigorous drying of the water-sensitive catalyst components thus increases the time and cost of catalyst production. One of the inventions disclosed is aqueous titanation of Cr/Silica catalysts using titanium acetylacetonate and another ligand such as a glycol, a carboxylate, a peroxide, or a combination thereof (U.S. Pat. No. 10,858,456, US 2020/0392264 A1, which are herein incorporated by reference). Other inventions in general disclose methods of aqueous titanation consisting of contacting a silica support with a Ti-containing solution to form a titanated silica support, wherein the Ti-containing solution consists of a Ti compound, a solvent (water), and additive(s) that chelate with the Ti-containing compound and/or change the solution pH to either increase the solubility of the Ti-compound in water or to improve the stability of the aqueous solution containing the Ti-compound. The additive consists of carboxylate and surfactant (U.S. Pat. No. 10,889,664, US 2021/0054112 A1), amino acid (US 2020/0392261 A1, US 2020/0392265 A1; US 2021/0292446 A1), or at least two components selected from the groups consisting of one or more carboxylic acids, one or more acidic phenols, one or more peroxide-containing compounds and one or more N-containing compounds (U.S. Pat. Nos. 10,894,250; 11,110,443). Each of the foregoing patents and published applications are herein incorporated by reference. A wide variety of Ti compounds are claimed to be suitable. However, the use of aqueous solutions of the Ti-containing compound makes these inventions non-suitable for the preparation of high-PV Cr/Ti/Silica catalysts.

The disclosed method for the preparation of titanium-modified Cr/Silica catalyst precursors (Cr/Ti/Silica precursors) and resulting catalysts are directed to overcoming one or more of the problems set forth above and/or other problems of the prior art. In particular, the present disclosure solves the need for an economic process to prepare a Cr/Ti/Silica catalyst with high PV and consistently high MI potential.

### SUMMARY

In one embodiment, there is described a method for making titanium-modified Cr/Silica catalyst precursor, comprising: providing a silica support; providing a coating solution that contains: a Cr-containing compound, a Ti-containing compound selected from a titanium acetylacetonate having the following formula: (RO)(R′O)Ti(CH₃COCHCOCH₃)₂, Titanium bis-(triethanolamine) diisopropoxide or a combination thereof; and an organic containing solvent.

In one embodiment, the Ti-containing compound comprises a titanium acetylacetonate, wherein R=C₂H₅ and R′=i-C₃H₇. In another embodiment, the Ti-containing compound comprises a titanium acetylacetonate, wherein R=R′=i-C₃H₇.

In one embodiment, the method described herein further comprises mixing the coating solution with the silica support to form a catalyst preparation mixture, wherein the catalyst preparation mixture contains water in an H₂O:Ti molar ratio ranging from 2-50, such as from 4-40, or even from 10-30; and drying the catalyst preparation mixture to produce a Cr/Ti/Silica catalyst precursor. In one embodiment, the catalyst precursor may have a pore volume (PV) of at least 1.5 ml/g, chromium in an amount ranging from 0.01 wt % to 3 wt %, and titanium in an amount ranging from 0.1 wt % to 8 wt %. In one embodiment, mixing the coating solution with the silica support to form a catalyst preparation mixture can be done via incipient wetness impregnation of the silica support with the coating solution.

In one embodiment, the Cr/Ti/Silica catalyst precursor has a PV of at least 1.8 ml/g, such as at least 2.0 ml/g. In one embodiment, the Cr/Ti/Silica catalyst precursor has a PV ranging from 1.8 to 2.8 ml/g.

In one embodiment, the Cr compound is soluble in the solvent and can be converted to chromium oxide by calcining. Non-limiting examples of the Cr compound include chromium nitrate, chromium acetate, ammonium chromate, tert-butyl chromate, or mixtures thereof. In one embodiment, the Cr compound comprises basic chromium acetate (BCA) having the general formula (Crₓ(OOCCH₃)_{y}(OH)_{3x-y}·nH₂O.

In one embodiment, the solvent comprises at least one alcohol, or a mixture of alcohols. In one embodiment, the alcohol contains water in an amount of H₂O:Ti molar ratio up to 30.

In one embodiment, the method described herein further comprises pyrolyzing the catalyst precursor under an inert atmosphere. For example, the pyrolyzing step may be performed in an inert atmosphere at a temperature ranging from 400 to 700° C. to form a pyrolyzed catalyst precursor. In one embodiment, the method further comprises activating the catalyst precursor or the pyrolyzed catalyst precursor in an oxidizing atmosphere at temperatures ranging from about 400 to about 900° C. to convert the catalyst precursor or the pyrolyzed catalyst precursor to an activated catalyst, such as a Cr/Ti/Silica olefin polymerization catalyst. Thus, there is also disclosed a Cr/Ti/Silica catalyst precursor made by the method described herein.

It is to be understood that both the foregoing general description and the following detailed description are exemplary and explanatory only and are not restrictive of the subject matter that may be claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a line graph of catalyst PV versus the amount of water in the catalyst preparation system, expressed as H₂O:Ti molar ratio, for a variety of different Ti-containing compounds. The ratio is for water that is introduced through the coating solution. All catalyst precursors are prepared from silica supports of similar SA and PV, and all catalyst precursors contain about 2.5% Ti.

FIG. 2 is a line graph of relative HLMI versus the amount of water in the catalyst

preparation system, expressed as H₂O:Ti molar ratio, for a variety of different Ti-containing compounds. The ratio is for water that is introduced through the coating solution. All catalyst precursors are prepared from silica supports of similar SA and PV, and all catalyst precursors contain about 2.5% Ti except for the catalyst labeled as Comp 8.

FIG. 3 is a line graph of relative HLMI versus the amount of water in the catalyst preparation system, expressed as H₂O:Ti molar ratio for two different Ti-containing compounds: titanium n-butoxide (TnBT) and Titanium acetylacetonate (such as Tyzor® AA75). The ratio is for water introduced through the silica support. All catalyst precursors are prepared from silica supports of similar SA and PV, and all catalyst precursors contain about 2.5 wt % Ti.

### DETAILED DESCRIPTION

### Definitions

As used herein, “high pore volume (PV)” for Cr/Ti/Silica catalysts means a PV of 1.5 or greater, such as a PV of 1.8 or greater, or a PV of 2.0 or greater. In one embodiment, a high PV is at least 2.2 ml/g.

As used herein, “high load melt index” (HLMI) is a measure of the molten polymer fluidity, and is inversely related to the average molecular weight of polymer, as measured in accordance with ASTM D-1238-4 using load of 21.6 kg at 190° C.

As used herein, “MI potential” of a Cr catalyst described herein is a function of, and is directly proportional to, the MI of the polymer produced from that catalyst under specified catalyst activation temperature and polymerization conditions.

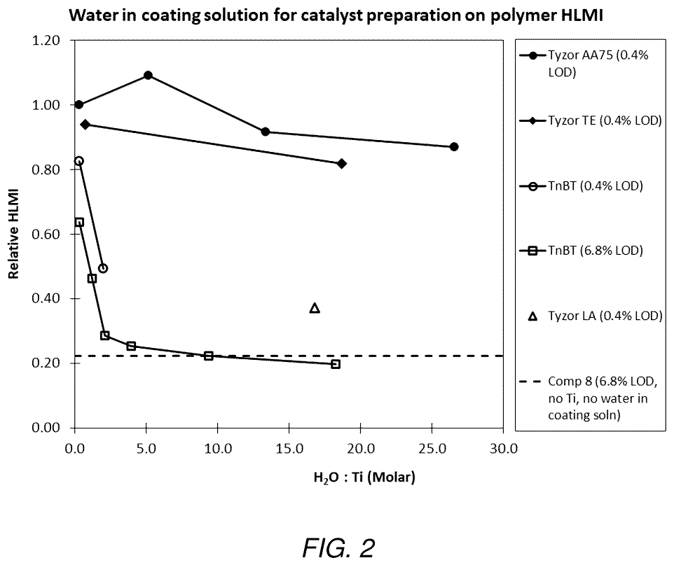

As used herein, “high Melt Index (MI) potential” is defined with respect to the catalyst in FIG. 2 made using Tyzor AA75, and with a total H₂O:Ti molar ratio of 0.7 (see, e.g., Comp 13 at Table 3) which corresponds to catalyst preparation mixture essentially free of water.

This catalyst is the Reference Catalyst. As shown in FIG. 2, the relative HLMI for HDPE produced from this Reference Catalyst is 1.0. If the relative HLMI of the HDPE produced from another high-PV Cr/Ti/Silica catalyst (the “Catalyst”) is > about 0.85, then the Catalyst is considered to have high MI potential. Thus, “high MI potential” means that the Catalyst produces HDPE of HLMI that is at least about 85% of the HLMI of the HDPE produced from the Reference Catalyst, then the Catalyst has high MI Potential, if the following conditions are also met: (a) the Catalyst has similar properties to the Reference Catalyst in porosity, metal contents (Cr and Ti), purity and particle size; and (b) the Catalyst is activated under the same conditions and ethylene polymerization is conducted under the same conditions as the Reference Catalyst.

Prior to the present disclosure, the prior art taught that to prepare a high PV Ti-modified Cr catalyst of high MI potential by impregnation, the catalyst preparation system (or the catalyst preparation mixture) has to be substantially free of water/moisture. This required extensive drying of silica support and using of pure organic solvent which adds manufacturing cost. Surprisingly, it was discovered by the present inventors that by using Ti acetylacetonate (for example, manufactured by Dorf Ketal, and sold under the tradename, Tyzor® AA) or Titanium bis-(triethanolamine) diisopropoxide (for example, also manufactured by Dorf Ketal, and sold under the tradename, Tyzor® TE), it was possible to achieve high PV and high MI response even when the catalyst preparation system contains high concentration of water.

Water/moisture can be introduced into the catalyst preparation system through silica support and/or through the coating solution that is comprised of the Cr-containing compound, the Ti-containing compound and the organic solvent. The amount of water introduced through the support, as water of hydration, is quantified by support loss-on-drying measured at 120° C. (LOD) and the weight of support used. Water introduced through coating solution can be from the Cr-containing compound as water of hydration or as water in the aqueous solution of the Cr-containing compound, from the Ti-containing compound (for water-stable Ti-containing compound only), and from the organic solvent. The content of water can be expressed as weight percentage (wt %) of the total catalyst preparation mixture (silica support and the coating solution) or as the H₂O:Ti molar ratio. In the case of catalyst preparation by incipient wetness impregnation, the conversion between wt % and H₂O:Ti molar ratio will be dependent on silica support PV as it determines the volume of the coating solution required and the catalyst Ti content target.

In one embodiment, water was introduced into the catalyst preparation system mainly through the coating solution. It was discovered that when titanium acetylacetonate in the form of Tyzor® AA75 was used as the titanium-containing compound, both the PV of the Cr/Ti/Silica catalyst precursor and the MI response of the resulting catalyst were surprisingly tolerant to the presence of water in the coating solution. In comparison, when titanium n-butoxide (TnBT) was used as the titanium-containing compound, although the PV of the Cr/Ti/Silica catalyst precursor was quite tolerant to the presence of water, the MI response of the resulting Cr/Ti/Silica catalyst was drastically reduced even when a small amount of water/moisture was present.

The present disclosure also shows the unpredictability associated with how Ti-containing compounds affect the tolerance of water in the catalyst preparation system in terms of the PV of the Cr/Ti/Silica catalyst precursor and the MI potential of the resulting Cr/Ti/Silica catalyst. For example, it was further shown that titanium bis-(triethanolamine) diisopropoxide, (Tyzor® TE), although having good resistance to hydrolysis, was not as good of a candidate as a titanium acetylacetonate (Tyzor® AA75) but the reductions in PV and MI response are relatively small when water was present in the catalyst preparation system. In contrast, Ti(IV) bis(ammonium lactato)dihydroxide (Tyzor® LA), a water-stable Ti-containing compound, showed that both the PV of the Cr/Ti/Silica catalyst precursor and the MI response of the resulting catalyst were reduced substantially.

In one embodiment, the H₂O:Ti molar ratio and the wt % are defined in terms of water that is introduced through the coating solution. The H₂O:Ti molar ratio can be up to 30, such as up to 25, such as up to 20 without significantly reducing the PV of the catalyst precursor nor the MI potential of the resulting catalyst. For Cr/Ti/Silica catalyst precursors prepared from silica gel support of ˜2.6 ml/g PV and having a target catalyst Ti content of 2.5 wt %, the above H₂O:Ti molar ratios correspond to ˜10 wt %, ˜8 wt % and ˜7 wt % water in catalyst preparation mixture.

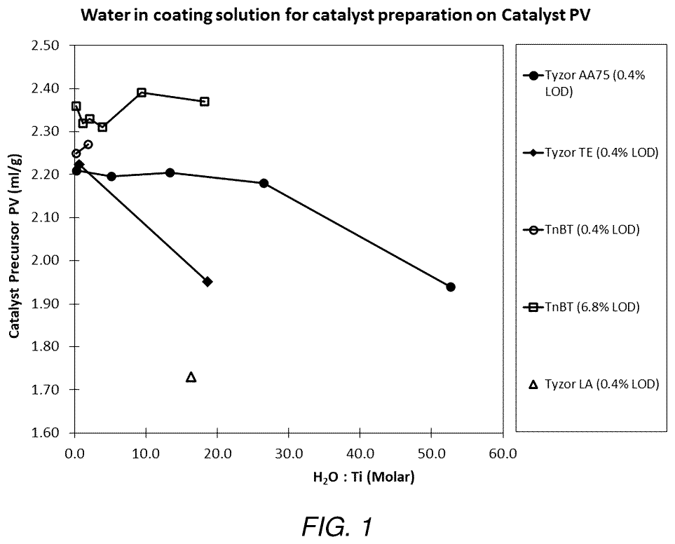

FIG. 1 is a line graph of catalyst precursor PV versus the amount of water in the catalyst preparation system, expressed as H₂O:Ti molar ratio, for a variety of different Ti-containing compounds in terms of water that is introduced through the coating solution. All catalyst precursors contained 1.0 wt % Cr and about 2.5 wt % Ti. All catalyst precursors also had similar SA (˜500 m²/g). It was discovered that when certain Ti-containing compounds were used, the PV of the Cr/Ti/Silica catalyst precursor was surprising tolerant to the presence of water in the coating solution. In one non-limiting embodiment for catalyst precursor prepared from a titanium acetylacetonate (Tyzor® AA75), the PV remained nearly unchanged when the coating solution had an H₂O:Ti molar ratio up to about 30. The PV was noticeably reduced but still maintained above 1.9 ml/g even when the coating solution had an H₂O:Ti molar ratio of 53.

FIG. 2 shows a line graph of relative HLMI versus H₂O:Ti molar ratio for a variety of different Ti-containing compounds in terms of water that is introduced through the coating solution. Catalyst precursor samples are the same as in FIG. 1. The broken line indicates the relative HLMI of the polymer prepared from a Cr/Silica catalyst precursor of similar SA and 2.32 ml/g PV but without Ti modification. As evident in FIG. 2, the relative HLMI remains nearly constant (within experimental error) for catalyst prepared from titanium acetylacetonate (Tyzor® AA75) and titanium bis-(triethanolamine) diisopropoxide (Tyzor® TE) even when the coating solution contained water in an H₂O:Ti molar ratio up to about 30, such as up to 20. These Ti-containing compounds were found to be tolerant to the presence of water in the coating solution, especially compared to other Ti-containing compounds, such as titanium n-butoxide (TnBT) or Ti(IV) bis(ammonium lactato)dihydroxide (Tyzor® LA).

In another embodiment, water is introduced into the catalyst preparation system mainly through the silica support, in the form of water of hydration. When water is introduced through silica support, the H₂O:Ti molar ratio can reach up to 50, and can range from 2-50, such as from 4-40, such as from 10-30 with relatively small reduction in the PV of the catalyst precursor and negligible reduction in the MI potential of the resulting catalyst. For Cr/Ti/Silica catalyst precursors prepared from silica gel support of ˜2.6 ml/g PV and having a target catalyst Ti content of 2.5 wt %, the above H₂O:Ti molar ratios correspond to ˜15 wt %, ˜1-12 wt % and ˜3-9 wt % water in catalyst preparation mixture.

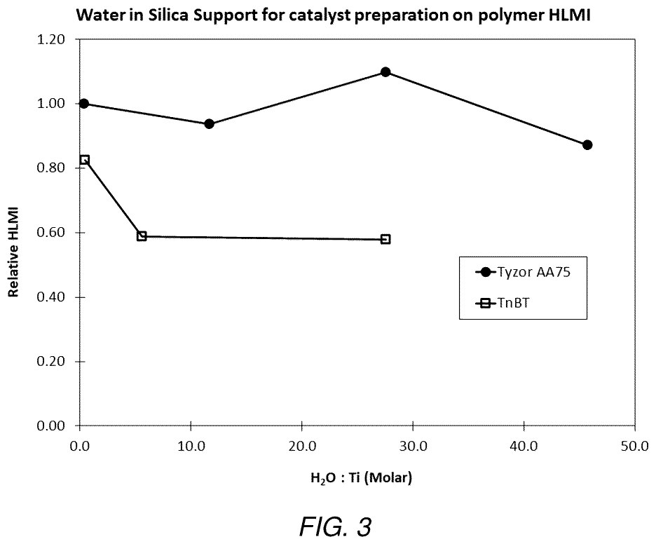

FIG. 3 shows a line graph of relative HLMI versus H₂O:Ti molar ratio for two different Ti containing compounds: titanium n-butoxide (TnBT) and titanium acetylacetonate (Tyzor® AA75) in terms of water that is introduced through the silica support. As evident in this figure, the relative HLMI remains nearly constant for catalyst prepared from Titanium acetylacetonate (such as Tyzor® AA75) even when the silica support contained water in an H₂O:Ti molar ratio up to about 46. In contrast, the relative HLMI of catalyst prepared from TnBT drops to about 0.6 when the support contained water in an H₂O:Ti molar ratio of about 6.

Not wishing to be bounded by theory, the presence of water in the catalyst preparation system can bring two detrimental effects to the MI potential of a high-PV Cr/Ti/Silica catalysts. It can lower the PV of the catalyst thus reduce the MI potential of the catalyst. It can also hydrolyze a water-sensitive Ti-containing compound, such as TnBT, cause oligomerization and polymerization of the Ti-containing compound forming Ti species in the coating solution and/or on the silica support surface that are less efficient in boosting catalyst MI potential. It was surprisingly found that, when the hydrolysis-resistant titanium acetylacetonate (such as Tyzor® AA) or Titanium bis-(triethanolamine) diisopropoxide (such as Tyzor® TE), particularly titanium acetylacetonate, is used as the Ti-containing compound to prepare the high-PV Cr/Ti/Silica catalyst, both the PV of the catalyst precursor and the effectiveness of the Ti added to boost catalyst MI potential are tolerant to the presence of water/moisture in the catalyst preparation system. As illustrated in FIGS. 2 and 3, even with the catalyst preparation system contains water in an H₂O:Ti molar ratio up to 50, or up to 40, or up to 30, either introduced through the silica support or through the coating solution, the relative HLMI is maintained at about >0.85. Therefore, this invention allowed the disclosed process to avoid common, time consuming drying steps used in prior art method for high-PV Cr/Ti/Silica catalyst manufacturing.

In one embodiment, there is disclosed a method to manufacture a Cr/Ti/Silica catalyst with high PV and consistently high MI potential without resorting to vigorous drying of the water-sensitive components such as the silica support and/or the organic solvent (such as an alcohol). This embodiment utilizes a suitable Ti-containing compound, such as titanium acetylacetonate or titanium bis-(triethanolamine) diisopropoxide. Although the incorporation of the Cr-containing compound and the incorporation of the Ti-containing compound can be done separately and the order of the incorporation can be reversed, one exemplary method from an economic point of view is to incorporate the Cr-containing compound and the Ti-containing compound simultaneously. It was discovered that by mixing a silica support of high PV with a solution containing a suitable Cr-containing compound, a Ti-containing compounds, such as but not limited to titanium acetylacetonate or titanium bis-(triethanolamine) diisopropoxide, and an alcohol as the solvent (coating solution), a Cr/Ti/Silica catalyst of high PV and consistently high MI potential can be prepared from this mixture that, when considered cumulatively, contains substantial amount of water. The inclusion of water in an H₂O:Ti molar ratio up to 50, or up to 40, or up to 30, in the mixture of the silica support and the coating solution has small impact on the PV of the catalyst precursor and negligible impact on the MI potential of the Cr/Ti/Silica catalyst prepared. Therefore there is no need for rigorous drying of the silica support, nor need for alcohol that is substantially free of moisture, to prepare a Cr/Ti/Silica catalyst that has not only high PV but also consistently high MI response.

In one embodiment, the catalyst preparation procedure includes:
choosing a silica support that has the desired porosity, purity, particle size and size distribution. The support can contain a moisture content in an H₂O:Ti molar ratio up to 50, and from 2-50, such as from 4-40, such as from 10-30. In one embodiment, the silica support contains water in an amount of H₂O:Ti molar ratio up to 45, or up to ˜13 wt % in the catalyst preparation mixture for a silica support of ˜2.6 ml/g PV and a target catalyst Ti content of 2.5%, and be used for preparation as-is.
preparing a coating solution containing a Cr-containing compound, a Ti-containing compound and a solvent in the form of an alcohol that may contain water in an amount of H₂O:Ti molar ratio up to 30. Non-limiting examples of Ti-containing compounds that can be used herein include titanium acetylacetonate, or titanium bis-(triethanolamine) diisopropoxide.
the catalyst precursor suitably comprises from 0.01 to 3% by weight of chromium expressed as element, such as 0.1 to 2%, or even from 0.25-1.5%. The catalyst precursor suitably comprises from 0.1 to 8% by weight of titanium expressed as element, such as from 0.5 to 5%, or even from 1 to 4%.
mixing the coating solution with the silica support. In one embodiment, incipient wetness impregnation of the silica support with the coating solution is the employed technique. When considered cumulatively, the catalyst preparation mixture contains water in an H₂O:Ti molar ratio up to 50, or up to 40, or up to 30, with exemplary ranges including 2 to 50, such as 4 to 40 or even 10 to 30, including water from silica support and the coating solution.
drying the mixture to produce the Cr/Ti/Silica catalyst precursor.
optionally pyrolyzing the catalyst precursor under an inert atmosphere, such as N₂, at temperatures ranging from about 400 to about 700° C., to produce the pyrolyzed catalyst precursor.
activating the catalyst precursor or the pyrolyzed catalyst precursor in an oxidizing atmosphere, such as dry air, at temperatures ranging from about 400 to about 900° C. to convert the catalyst precursor to activated catalyst.

In one embodiment, there is described the use of titanium acetylacetonate in the disclosed method. If a more hydrolysable Ti compound, such as Ti alkoxide Ti(OR)₄ (where all R can be the same or different), is used for the preparation of the Cr/Ti/Silica catalyst, even the inclusion of a very small amount of water in the mixture has very detrimental effect on the MI potential of the Cr/Ti/Silica catalyst prepared even though the PV of the catalyst is not affected. Without being bound by theory, it is hypothesized that this is due to the oligomerization/polymerization of the readily hydrolysable Ti compound molecules, and the titanation of the Cr/Silica catalyst by these oligomerized/polymerized Ti species is much less effective in boosting catalyst MI potential.

Even when the dry alcohol solvent and pre-dried silica support are used in catalyst preparation, the Ti distribution among the particles of the Cr/Ti/Silica catalyst precursor prepared is quite non-uniform when Ti(OR)₄ is used as the Ti-containing compound if the Ti loading is below monolayer saturation of the silica support. This is markedly different from the Cr/Ti/Silica catalyst precursor prepared from titanium acetylacetonate. Even when the catalyst preparation mixture contains water in an H₂O:Ti molar ratio up to about 50, the catalyst precursor prepared has good Ti uniformity among particles. Ti distribution uniformity of the Cr/Ti/Silica catalyst precursor prepared from Titanium bis-(triethanolamine) diisopropoxide (such as Tyzor® TE) is between that prepared from Ti(OR)₄ and that from Titanium acetylacetonate (such as Tyzor® AA).

The Ti distribution uniformity among particles of the catalyst precursor was quantified by the following method. Under a Hitachi SU6600 scanning electron microscope (SEM), 60 particles were randomly selected from each catalyst precursor sample and analyzed for Ti content using the standardless Energy Dispersive X-ray Spectroscopy (EDS, Brucker Nano QUANTAX 200 system, with the Brucken Nano XFlash 6|30 detector attached to the Hitachi SEM unit). Ti content, which is reported on the weight basis of (SiO₂+TiO₂+Cr2O₃) was calculated based on the P/B-ZAF method on the Ti K line. The average Ti content and the standard deviation are calculated. The relative standard deviation (RSD), calculated according to Equation 1, is used to quantify the Ti distribution uniformity among particles. Lower RSD value means more uniform Ti distribution.

$$RSD = \frac{Standard deviation}{Average} \times 100 \qquad Equation 1$$

As described, MI potential of a Cr catalyst described herein is a function of, and is directly proportional to, the MI of the polymer produced from that catalyst. For example, when a Cr catalyst activated under specified temperature is used to polymerize ethylene under specified conditions, MI potential of the Cr catalyst is directly proportional to the HLMI of the polymerized ethylene. The higher the HLMI of the polymer, the higher the catalyst MI potential.

Density of the described polymers was measured in accordance of ASTM D-792-13.

The HLMI and density were measured on polyethylene pellets. The polymer powder samples were stabilized with antioxidants at 2000 ppm level. The antioxidants were a 1:1 mixture of BHT (butylated hydroxytoluene) and the sterically hindered phenolic primary antioxidant, pentaerythritol tetrakis[3-[3,5-di-tert-butyl-4-hydroxyphenyl] propionate, sold by BASF under the tradename, IRGANOXR 1010. The stabilized polymer powders were processed into pellets using a single screw extruder, Model RCP-0625 from Randcastle.

The levels of chromium (Cr) and titanium (Ti) in the catalyst composition were measured by X-ray fluorescence (XRF), using a PANalytical Magix Pro or Zetium Automatic Sequential Spectrometer. Samples were calcined at 1000° C. in air and then prepared as fused beads using a lithium borate flux. Fusion was typically between 1000 and 1250° C. Cr and Ti levels were reported as the weight percentage of the catalyst precursor after calcination at 1000° C.

Surface area (SA) and pore volume (PV) of catalyst precursor were measured by Nitrogen Porosimetry using an Autosorb-6 Testing Unit from Quantachrome Corporation (now Anton Paar GmbH). Samples were first degassed at 350° C. for at least 4 hours on the Autosorb-6 Degassing Unit. A multipoint surface area was calculated using the BET theory taking data points in the P/P₀ range 0.05 to 0.30. A pore volume measurement was recorded at P/P₀ of 0.984 on the desorption leg. In one embodiment, the surface area of the inorganic support material described herein ranges from 100 to 1000 m²/g, for instance from 200 to 800 m²/g, such as from 300 to 700 m²/g, for instance from 400 to 600 m²/g.

In one embodiment, the inorganic support material comprises a porous inorganic oxide, such as silica. In an embodiment, particle size of a silica support was measured by light scattering using an apparatus such as a Malvern Mastersizer™ model 2000 or 3000. The real value used for silica refractive index is 1.4564 and 0.1 for the imaginary refractive index of the particle, with water dispersant at 1.33 refractive index.

In one embodiment, the inorganic support material is typically in the form of particles having a median particle diameter from 1 to 300 micrometers (μm). The typical median diameter also applies to the catalyst precursor particles and to the activated catalyst particles, which have essentially the same particle diameter as the support material. In one embodiment, the particles have a d90 of 500 μm or less, such as 400 or less. They may have a d90 of 300 μm or less. The particles may have d10 of 1 μm or more, such as 10 or more. (For the sake of clarity, d90 is the diameter at which 90% of the particles have a diameter less than d90. Equivalent definitions apply to d50 and d10). In an embodiment, the particles have a d50 from 1 to 300 μm, such as from 5 to 250 μm, even from 25 to 150 μm.

In one embodiment, the inorganic support material has a porosity from 1.7 to 3.5 m/g or 2.1 to 3.3 ml/g, such as from 2.3 to 3.0 ml/g or even 2.5 to 3.0 ml/g.

### EXAMPLES AND EXPERIMENTAL

The following non-limiting examples, which are intended to be exemplary, further clarify the present disclosure.

Four batches of silica support of high purity were used for catalyst preparation. Properties of these support samples are summarized in Table 1. Metal impurities typically found in commercial silica gel manufactured from sodium silicate are below 100 ppm each.

TABLE 1
Properties of silica support samples

| | SA | PV | d10 | d50 | d90 |
|---|---|---|---|---|---|
| Batch | (m2/g) | (cc/g) | (μm) | (μm) | (μm) |
| A | 561 | 2.52 | 37 | 106 | 179 |
| B | 567 | 2.62 | 54 | 118 | 191 |
| C | 556 | 2.59 | 30 | 111 | 183 |
| D | 553 | 2.00 | 64 | 117 | 187 |

In one embodiment, the Cr-containing compound is basic chromium acetate, abbreviated as BCA, of the general formula (Cr₃(OOCCH₃)₇(OH)₂·xH₂O. The specific batch of BCA used has x about 2.6 corresponding to 24.0% Cr.

In various embodiments, the Ti-containing compounds used include:
Titanium alkoxide: Ti(OR)₄, R=n-C₄H₉ for titanium n-butoxide (TnBT), R=i-C₃H₇ for Ti isopropoxide (TiPT).
Titanium acetylacetonate: (RO)(R′O)Ti(CH₃COCHCOCH₃)₂, R=C₂H₅ and R′=i-C₃H₇ (CAS #445398-76-5) supplied by Dorf Ketal under the brand name of AA-105 (100% active ingredient) or R=R′=i-C₃H₇ (CAS #17927-72-9) supplied by Dorf Ketal under the brand name of AA-75 (75% active ingredient, 25% isopropanol).
Titanium bis-(triethanolamine) diisopropoxide: Ti(O-iC₃H₇)₂[N(C₂H₄OH)₂(C₂H₄O)]₂) (CAS #36673-16-2) supplied by Dorf Ketal under the brand name of Tyzor® TE as a solution in isopropanol.
Ti(IV) bis (ammonium lactato) dihydroxide: (NH₄)₂(CH₃CHOCOO)₂Ti(OH)₂ (CAS #65104-06-5) supplied by Dorf Ketal under the brand name of Tyzor® LA as a 50% aqueous solution.

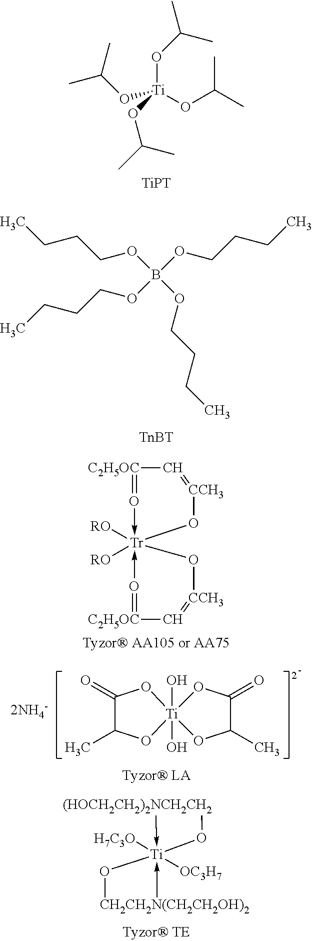

A non-limiting example of the general steps used in the preparation process for the catalyst precursor is provided below:
1. Select a silica support from the four batches listed in Table 3. This silica support is dried to different moisture content, expressed as LOD, ranging from 0.4 to about 30%, before use.
2. Prepare the coating solution by first dissolving basic chromium acetate (BCA) powders in methanol followed by addition of the Ti-containing compound into the solution and well mixed. The order of addition of BCA and the Ti-containing compound can be reversed. The total volume of the coating solution fills the total PV of the silica support (incipient wetness impregnation). The methanol may contain water content up to 30 wt %.
3. Impregnate the silica support with the coating solution using a suitable process, such as with a Rotovap machine. The coating solution can be added to the support in about 10 to 30 minutes followed by mixing for another 60 minutes.
4. Dry the silica support impregnated with the coating solution in a vacuum oven at 100° C. to obtain the catalyst precursor that is substantially free of solvent.
5. Optionally pyrolyze the catalyst precursor at elevated temperature, such as from 300-700° C., or even from 450-600° C. This step is done in an inert atmosphere such as nitrogen, to pyrolyze the organic ligands associated with BCA and Ti-containing compound.

Catalyst activation: about 10 g of the catalyst precursor or pyrolyzed catalyst precursor was activated in a fluidized bed quartz reactor using dry air as the fluidization gas (alternatively, the fluidization started with dry nitrogen as the fluidization gas then switched to dry air at 300-450° C. The temperature was held at 650° C. for 5 hours before cooling and subsequently switching to nitrogen at 300° C.

Bench polymerization: about 175 mg of activated catalyst was transferred to a 2.5 L isobutane slurry polymerization reactor and tested for ethylene polymerization with 1-hexene as the co-monomer. Concentration of ethylene in isobutane was controlled at 10 mol %. All polymerization runs were conducted at 100° C. but in some experiments 5 mL and in others 15 mL of 1-hexene was injected into the reactor, in one shot, at the beginning of polymerization. In all cases the polymerization reaction was terminated when a catalyst productivity of 2,500 g/g was reached. The reactor was vented and the polymer powders produced were recovered. Polymer powders were subsequently mixed with 2000 ppm antioxidants dissolved in acetone followed by drying to produce stabilized polymer powders. The antioxidants comprised 1:1 mixture of BHT and IRGANOX® 1010. These stabilized polymer powders were then converted into polymer pellets for HLMI and density determination.

### Comparative Examples 1-12

In these experiments for comparative examples, all catalyst precursor samples were prepared from titanium n-butoxide, which is a fast hydrolyzing Ti-containing compound, but from silica support of varying LOD ranging from 0.4% to 21%, corresponding to water in an H₂O:Ti molar ratio ranging from 0.4 to 28, and from coating solution containing varying water content up to an H₂O:Ti molar ratio ranging from 0.3 to 18, as summarized in Table 4. Thus, water was introduced to the catalyst preparation system from two sources-silica support and coating solution.

Water introduced to the catalyst preparation system through the silica support, through the coating solution, and through both silica support and coating solution, as the H₂O:Ti molar ratio and as the weight percentage of the catalyst preparation mixture (support+coating solution), are also listed Table 2. All catalyst precursors listed in Table 2 contain about 1.0% Cr and 2.5% Ti except catalyst precursor for Comp 8 that does not contain Ti. Table 2 also lists the SA and PV results of the catalyst precursors.

TABLE 2
Comparative examples (using TnBT as the Ti precursor)

| | Sample preparation | | | | | | | | | | | | |
|---|---|---|---|---|---|---|---|---|---|---|---|---|---|
| | | | | H₂O:Ti molar | | | H₂O wt % on mixture³ | | | Catalyst precursor | | | |
| | Suppot | | Coating | | From | | | From | | Porosity | | Ti Dist.⁴ | HDPE |
| | | LOD | Ti | From | coating | | From | coating | | SA | PV | EDS | Rel. |
| Example^{1, 2} | Batch | (wt %) | Comp | Sup | soln | Total | Sup | soln | Total | (m2/g) | (cc/g) | RSD | HLMI |
| Comp 1 | C | 0.4 | TnBT | 0.4 | 0.3 | 0.7 | 0.1 | 0.1 | 0.2 | 512 | 2.35 | n/d | 0.83 |
| Comp 2 | C | 6.8 | TnBT | 7.7 | 0.3 | 8.0 | 2.4 | 0.1 | 2.5 | 517 | 2.36 | n/d | 0.64 |
| Comp 3 | C | 6.8 | TnBT | 7.7 | 1.2 | 8.9 | 2.4 | 0.4 | 2.8 | 511 | 2.32 | n/d | 0.46 |
| Comp 4 | C | 6.8 | TnBT | 7.7 | 2.1 | 9.8 | 2.4 | 0.7 | 3.1 | 506 | 2.33 | n/d | 0.29 |
| Comp 5 | C | 6.8 | TnBT | 7.7 | 3.9 | 11.6 | 2.4 | 1.2 | 3.7 | 494 | 2.31 | n/d | 0.25 |
| Comp 6 | C | 6.8 | TnBT | 7.7 | 9.4 | 17.1 | 2.4 | 2.9 | 5.4 | 512 | 2.39 | n/d | 0.22 |
| Comp 7 | C | 6.8 | TnBT | 7.7 | 18.2 | 25.9 | 2.4 | 5.8 | 8.2 | 516 | 2.37 | n/d | 0.20 |
| Comp 8 | C | 6.8 | | | | | 2.5 | 0.1 | 2.6 | 511 | 2.32 | n/d | 0.22 |
| Comp 9 | B | 0.4 | TnBT | 0.4 | 0.3 | 0.7 | 0.1 | 0.1 | 0.2 | 477 | 2.25 | 50% | 0.83 |
| Comp 10 | A | 0.4 | TnBT | 0.4 | 2.0 | 2.4 | 0.1 | 0.7 | 0.8 | 529 | 2.27 | 53% | 0.49 |
| Comp 11 | A | 5.1 | TnBT | 5.6 | 0.3 | 5.8 | 1.8 | 0.1 | 1.9 | 514 | 2.25 | 63% | 0.59 |
| Comp 12 | B | 20.9 | TnBT | 27.5 | 0.3 | 27.8 | 8.1 | 0.1 | 8.2 | 520 | 2.14 | 59% | 0.58 |

All catalyst precursor samples in Table 2 were prepared from silica support having varying LOD, BCA, TnBT (except Comp 8 for which no TnBT was used), and Methanol containing varying amount of water. For Comp 1 to 8 (Experiment Set #1), polymerization was conducted in Reactor #1 and co-polymerization with 5 mL 1-Hexene. For Comp 9 to 12 (Experiment Set #2), polymerization was conducted in Reactor #2 and co-polymerization with 15 mL 1-Hexene. As used in Table 2, “mixture” means the catalyst preparation mixture comprising support and the coating solution. In addition, Ti distribution uniformity expressed as the relative standard deviation (RSD) of the Ti content determined by EDS on 60 randomly selected catalyst precursor particles.

All catalyst precursor samples were activated at 650° C. and bench polymerization experiments were conducted with 5 or 15 ml of 1-hexene as indicated in Table 2. As the experiments Set #1 and #2 were conducted at different periods of time (thus variations in the purity of various feeds) and using different bench polymerization reactors and different polymerization condition, it is not meaningful to compare the absolute values from these two sets of experiments. However, each set of experiments has a control catalyst precursor sample that was prepared from pre-dried silica support, BCA, Tyzor AA75 and pure methanol (Comp 13, see below). By normalizing polymer HLMI of each experiment against the polymer HLMI of its respective control catalyst, we can compare the relative HLMI between these two sets of experiments. The relative HLMI values are also listed in Table 2.

When TnBT was used as the Ti-precursor, the presence of water in an H₂O:Ti molar ratio up to about 28, equivalent to up to 8 wt % H₂O in the catalyst preparation mixture has negligible effect on the PV of the catalyst precursor. However, the presence of water in the catalyst preparation system, even as low as an H₂O:Ti molar ratio of 2.4, reduces catalyst MI potential substantially (see Comp 10). Water present in the coating solution has a much larger negative effect on catalyst MI potential than water present in the support at the same level of H₂O:Ti molar ratio. For example, water in an H₂O:Ti molar ratio of 2.0 introduced through coating solution and in an H₂O:Ti molar ratio of 0.4 introduced through silica support (total H₂O:Ti molar ratio of 2.4) dropped the relative HLMI to 0.49 (Comp 10). In contrast, water in an H₂O:Ti molar ratio of 7.7 introduced through silica support and in an H₂O:Ti molar ratio of 0.3 introduced through coating solution (total H₂O:Ti molar ratio of 8.0) only dropped the relative HLMI to 0.64 (Comp 2). Not wishing to be bound by theory, the detrimental effect of water in the catalyst preparation system on the MI potential of a Cr/Ti/Silica catalyst prepared from TnBT is likely due to the fast hydrolysis of TnBT by water. This not only caused the non-uniform distribution of Ti among different catalyst particles but also likely changed the specification of the Ti precursor and bonding of Ti with silica support. Water in the coating solution is readily available to hydrolyze TnBT whereas TnBT has to compete with silica surface hydroxyls for water in silica support, therefore water in the coating solution for Cr/Ti/Silica catalyst precursor prepared from TnBT is more detrimental to catalyst MI potential. The poor Ti distribution uniformity among catalyst precursor particles of the Cr/Ti/Silica catalyst prepared from TnBT is illustrated by the high relative deviation (RSD) in the Ti content of individual particles (between 50-60%).

### Inventive Examples 1-7 and Comparative Example 13

In these inventive examples, all catalyst precursor samples were prepared from titanium acetylacetonate: (RO)(R′O)Ti(CH₃COCHCOCH₃)₂, R=R′=i-C₃H₇ (CAS #17927-72-9) supplied by Dorf Ketal under the brand name Tyzor® AA75 as the Ti-containing compound, which is a slow hydrolyzing Ti precursor. The silica support has varying LOD up to 30 wt %, corresponding to an H₂O:Ti molar ratio up to 46. The coating solution contains varying amount of water, ranging from water in an H₂O:Ti molar ratio 5 to 53. The total water content varies from water in an H₂O:Ti molar ratio ranging from 5 to 53. Table 3 summarizes catalyst preparation conditions. As in the Comparative Examples, all catalyst precursors listed in Table 3 contain about 1.0% Cr and 2.5% Ti. All catalyst precursor samples were determined for SA and PV and results are listed in Table 3. All catalyst precursor samples except one were analyzed for Ti distribution uniformity. Results are also listed in Table 3. The control sample, labelled as Comp 13, was prepared similarly to Inventive Examples 1-7 except that the Comp 13 was prepared from catalyst preparation mixture that was essentially free of water, in an H₂O:Ti molar ratio of 0.7, following the process disclosed in prior art.

All catalyst precursor samples were activated at 650° C. Polymerization experiments were performed at 100° C. with 15 mL of 1-hexene. Polymer samples prepared were stabilized, pelletized and determined for HLMI. The relative HLMI was calculated using Comp 13 as the control.

TABLE 3
Inventive examples 1-7; Comp. Example 13 (Tyzor ® AA75 as the Ti-precursor)

| | Sample preparation | | | | | | | | | | | | |
|---|---|---|---|---|---|---|---|---|---|---|---|---|---|
| | | | | H₂O:Ti molar | | | H₂O wt % on mixture | | | Catalyst precursor | | | |
| | Suppot | | Coating | | From | | | From | | Porosity | | Ti Dist. | HDPE |
| | | LOD | Ti | From | coating | | From | coating | | SA | PV | EDS | Rel. |
| Example | Batch | (wt %) | Comp | Sup | soln | Total | Sup | soln | Total | (m2/g) | (cc/g) | RSD | HLMI |
| Comp 13 | A | 0.4 | AA75 | 0.4 | 0.3 | 0.7 | 0.1 | 0.1 | 0.2 | 488 | 2.21 | 8% | 1.00 |
| (control) | | | | | | | | | | | | | |
| Inv 1 | A | 0.4 | AA75 | 0.4 | 5.2 | 5.6 | 0.1 | 1.7 | 1.9 | 481 | 2.20 | 6% | 1.09 |
| Inv 2 | A | 0.4 | AA75 | 0.4 | 13.4 | 13.8 | 0.1 | 4.5 | 4.6 | 492 | 2.20 | 7% | 0.92 |
| Inv 3 | A | 0.4 | AA75 | 0.4 | 26.5 | 27.0 | 0.1 | 8.9 | 9.0 | 506 | 2.18 | 12% | 0.87 |
| Inv 4 | A | 0.4 | AA75 | 0.4 | 52.7 | 53.1 | 0.1 | 17.6 | 17.7 | 522 | 1.94 | | |
| Inv 5 | B | 10.1 | AA75 | 11.7 | 0.3 | 11.9 | 3.6 | 0.1 | 3.6 | 491 | 2.31 | 9% | 0.94 |
| Inv 6 | B | 20.9 | AA75 | 27.5 | 0.3 | 27.8 | 8.1 | 0.1 | 8.1 | 496 | 2.13 | 8% | 1.10 |
| Inv 7 | B | 30.4 | AA75 | 45.8 | 0.3 | 46.1 | 12.8 | 0.1 | 12.9 | 497 | 2.06 | 6% | 0.87 |

With regard to Table 3, Comp 13 and Inv 1-7, polymerization was conducted in Reactor #2 and co-polymerization with 15 mL 1-Hexene. When titanium acetylacetonate: (RO)(R′O)Ti(CH₃COCHCOCH₃)₂, R=R′=i-C₃H₇ (CAS #17927-72-9, supplied by Dorf Ketal under the brand name Tyzor® AA75) was used as the Ti-containing compound for the catalyst precursor preparation, the presence of water in an H₂O:Ti molar ratio up 30 had negligible effect on the PV of the catalyst precursor. Neither did it have significant effect on catalyst MI potential. When the catalyst preparation mixture contained water at an H₂O:Ti molar ratio of about 46 (Inv 1-7), appreciable PV reduction was observed. Despite the appreciable PV reduction, the relative HLMI was still maintained at 87%. These results demonstrate that when AA75 was used as the Ti-containing compound for Cr/Ti/Silica catalyst preparation, this system is remarkably tolerant to the presence of water in the system.

Cr/Ti/Silica catalyst precursors prepared from titanium acetylacetonate: (RO)(R′O)Ti(CH₃COCHCOCH₃)₂, R=R′=i-C₃H₇ (CAS #17927-72-9) (Tyzor® AA75) had much improved Ti distribution uniformity as determined by SEM-EDS. The RSD of Ti among particles ranges from 6 to 12% which is much lower than the RSD ranging from 50-60% for catalyst precursors prepared from TnBT.

### Comparative Example 14 and Inventive Example 8

Titanium acetylacetonate is more stable against hydrolysis. However, the high tolerance of the Cr/Ti/Silica catalyst prepared from this Ti-containing compound against the presence of water in the catalyst preparation mixture, as far as catalyst MI potential is concerned, is not entirely due to its slow hydrolysis nature. Tyzor® LA is a water-stable Ti chelate compound and is commercially available as an aqueous solution at 50% concentration. This Ti-containing compound, together with BCA and pure MeOH, were used to prepare a Cr/Ti/Silica catalyst sample containing 1% Cr and 2.5% Ti from silica support A. Although pure methanol was used as the solvent for coating solution preparation, water was introduced into the coating solution from Tyzor® LA and the total water in the catalyst preparation system equated to an H₂O:Ti molar ratio of 17.

Surprisingly, the PV of the catalyst precursor was substantially lower, 1.73 ml/g, than the PV of the Cr/Ti/Silica catalysts prepared from either TnBT or titanium acetylacetonate (such as Tyzor® AA) with formulations that have water content similar to or even higher in the catalyst preparation mixture. To eliminate the effect of catalyst PV on MI response, a Cr/Ti/Silica catalyst precursor from this invention was prepared from a silica support of lower PV (support D) using titanium acetylacetonate: (RO)(R′O)Ti(CH₃COCHCOCH₃)₂, R=R′=i-C₃H₇ (CAS #17927-72-9) supplied by Dorf Ketal under the brand name Tyzor® AA75 as the Ti-containing compound, BCA and methanol containing water equivalent to an H₂O:Ti molar ratio of 12. This catalyst precursor had 1.0% Cr and 2.5% Ti. This catalyst also had SA and PV closely matching those of the catalyst precursor prepared from Tyzor® LA (see Table 4). Catalyst precursor prepared from Tyzor® LA had much lower MI potential, at about 37% of the one prepared from titanium acetylacetonate (i.e., Tyzor® AA75). It also has less uniform Ti distribution among particles.

TABLE 4

| | Sample preparation | | | | | | | | | | | | |
|---|---|---|---|---|---|---|---|---|---|---|---|---|---|
| | | | | H₂O:Ti molar | | | H₂O wt % on mixture | | | Catalyst precursor | | | |
| | Suppot | | Coating | | From | | | From | | Porosity | | Ti Dist. | HDPE |
| | | LOD | Ti | From | coating | | From | coating | | SA | PV | EDS | Rel. |
| Example | Batch | (wt %) | Comp | Sup | soln | Total | Sup | soln | Total | (m2/g) | (cc/g) | RSD | HLMI |
| Comp 14 | A | 0.4 | Tyzor LA | 0.4 | 16.3 | 16.8 | 0.1 | 5.3 | 5.5 | 503 | 1.73 | 35% | 0.37 |
| Inv 8 | D | 0.4 | AA75 | 0.4 | 11.5 | 11.9 | 0.2 | 4.4 | 4.6 | 493 | 1.71 | 11% | 1.00 |

### Inventive Example 9 and Comparative Examples 13 and 15

Titanium bis-(triethanolamine) diisopropoxide (supplied by Dorf Ketal under the brand name Tyzor® TE) is another Ti-containing compound that is more stable than titanium alkoxides (such as titanium isopropoxide and titanium n-butoxide) against hydrolysis. Two Cr/Ti/Silica catalyst precursor samples were prepared from Titanium bis-(triethanolamine) diisopropoxide (Tyzor® TE), BCA, and either pure methanol (Comp 15) or methanol containing water (Inv 9). Details were summarized in Table 5. For comparison purpose, Table 5 also lists Comp 13. Compared to catalyst prepared from titanium acetylacetonate (i.e., Tyzor® AA), catalyst prepared from titanium bis-(triethanolamine) diisopropoxide (Tyzor® TE) is slightly less tolerant to the presence of moisture in the catalyst preparation system, but it is much more tolerant than catalyst prepared from TnBT. With the presence of water in an H₂O:Ti molar ratio of 19, the PV of the catalyst precursor from titanium bis-(triethanolamine) diisopropoxide (Tyzor® TE) is lower than those from TnBT and Titanium acetylacetonate (such as Tyzor® AA) at same level of water in the catalyst preparation mixture. The Ti distribution uniformity is between catalyst precursors prepared from AA and TnBT.

TABLE 5

| | Sample preparation | | | | | | | | | | | | |
|---|---|---|---|---|---|---|---|---|---|---|---|---|---|
| | | | | H₂O:Ti molar | | | H₂O wt % on mixture | | | Catalyst precursor | | | |
| | Suppot | | Coating | | From | | | From | | Porosity | | Ti Dist. | HDPE |
| | | LOD | Ti | From | coating | | From | coating | | SA | PV | EDS | Rel. |
| Example | Batch | (wt %) | Comp | Sup | soln | Total | Sup | soln | Total | (m2/g) | (cc/g) | RSD | HLMI |
| Comp 13 | A | 0.4 | AA75 | 0.42 | 0.3 | 0.7 | 0.1 | 0.1 | 0.2 | 488 | 2.21 | 8% | 1.00 |
| (control) | | | | | | | | | | | | | |
| Comp 15 | B | 0.4 | Tyzor TE | 0.42 | 0.3 | 0.7 | 0.1 | 0.1 | 0.2 | 484 | 2.22 | 30% | 0.94 |
| Inv 9 | B | 0.4 | Tyzor TE | 0.42 | 18.2 | 18.7 | 0.1 | 5.7 | 5.8 | 504 | 1.95 | 45% | 0.82 |

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A method for making titanium-modified Cr/Silica catalyst precursor, comprising:
providing a silica support;
providing a coating solution that contains:
a Cr-containing compound,
a Ti-containing compound selected from a Titanium acetylacetonate having the following formula: (RO)(R′O)Ti(CH₃COCHCOCH₃)₂, Titanium bis-(triethanolamine) diisopropoxide or a combination thereof, and
an organic containing solvent,
mixing the coating solution with the silica support to form a catalyst preparation mixture, wherein the catalyst preparation mixture contains water in an H₂O:Ti molar ratio ranging from 2-50; and
drying the catalyst preparation mixture to produce a Cr/Ti/Silica catalyst precursor having:
a pore volume (PV) of at least 1.5 cc/g,
chromium in an amount ranging from 0.01-3 wt %, and
titanium in an amount ranging from 0.1 wt % to 8 wt %.

2. The method of claim 1, wherein the Cr/Ti/Silica catalyst precursor has a PV of at least 1.8 ml/g.

3. The method of claim 1, wherein the Cr/Ti/Silica catalyst precursor has a PV ranging from 1.8 to 2.8 ml/g.

4. The method of claim 1, wherein the catalyst preparation mixture contains water in an H₂O:Ti molar ratio ranging from 4-40.

5. The method of claim 4, wherein the catalyst preparation mixture contains water in an H₂O:Ti molar ratio ranges from 10-30.

6. The method of claim 1, wherein the Ti-containing compound comprises titanium acetylacetonate, wherein R=C₂H₅ and R′=i-C₃H₇.

7. The method of claim 1, wherein the Ti-containing compound comprises titanium acetylacetonate, wherein R=R′=i-C₃H₇.

8. The method of claim 1, wherein the Cr compound is soluble in the solvent and can be converted to chromium oxide by calcining.

9. The method of claim 8, wherein the Cr compound comprises chromium nitrate, chromium acetate, ammonium chromate, tert-butyl chromate, or mixtures thereof.

10. The method of claim 6, wherein the Cr compound comprises basic chromium acetate (BCA) having the general formula (Crₓ(OOCCH₃)_{y}(OH)_{3x-y}·nH₂O.

11. The method of claim 1, wherein the organic containing solvent comprises at least one or more alcohols.

12. The method of claim 11, wherein the alcohol contains water in an amount of H₂O:Ti molar ratio up to 30.

13. The method of claim 1, further comprising pyrolyzing the catalyst precursor under an inert atmosphere.

14. The method of claim 13, wherein said pyrolyzing is performed in an inert atmosphere at a temperature ranging from 400 to 700° C. to form a pyrolyzed catalyst precursor.

15. The method of claim 14, further comprising activating the catalyst precursor or the pyrolyzed catalyst precursor in an oxidizing atmosphere at temperatures ranging from about 400 to about 900° C. to convert the catalyst precursor or the pyrolyzed catalyst precursor to an activated catalyst.

16. The method of claim 15, wherein the activated catalyst comprises a titanium-modified Cr/Silica olefin polymerization catalyst.

17. The method of claim 1, wherein the silica support contains water in an amount of H₂O:Ti molar ratio up to 45.

18. The method of claim 1, wherein mixing the coating solution with the silica support to form a catalyst preparation mixture is done via incipient wetness impregnation of the silica support with the coating solution.

19. A titanium-modified Cr/Silica catalyst precursor made by the method of claim 1.

20. The titanium-modified Cr/Silica catalyst precursor of claim 19, which has a pore volume (PV) of at least 1.5 ml/g.

21. The titanium-modified Cr/Silica catalyst precursor of claim 19, which has a pore volume (PV) of at least 1.8 ml/g.

22. The titanium-modified Cr/Silica catalyst precursor of claim 19, which a pore volume (PV) ranging from 1.8 to 2.8 ml/g.

23. The titanium-modified Cr/Silica catalyst precursor of claim 19, which is a precursor for a titanium-modified Cr/Silica olefin polymerization catalyst.
